(19) United States
(12) Patent Application Publication
(10) Pub. No.: US 2004/0051626 A1
(43) Pub. Date: Mar. 18, 2004

(54) System and method for providing access from a remote location

(76) Inventor: David Pautler, Palo Alto, CA (US)

Correspondence Address: FOLEY & LARDNER, 777 EAST WISCONSIN AVENUE, SUITE 3800, MILWAUKEE, WI, 53202-5308, US

(21) Appl. No.: 10/246,309

(22) Filed: Sep. 18, 2002

(51) Int. Cl. H04Q 1/00; G05B 19/00

(52) U.S. Cl. 340/5.61; 340/5.73

(57) ABSTRACT

An apparatus for providing access to a secured space from a remote location is described. The apparatus includes a control circuit, a communication device coupled to the control circuit and configured to send and receive data to and from a remote location, an access means configured to provide access to the secured space, and an access means retention device coupled to the control circuit and configured to provide access to the access means stored therein based on a communication using the communication device.

### BACKGROUND OF THE INVENTION

The present invention relates generally to a system and method for providing access to a locked or otherwise secured area from a remote location. More specifically, an exemplary embodiment of the present invention relates to a system for and method of providing access from a remote location using a communication device by utilizing the communication device to provide access to a stored device that can be used to gain access.

Security and convenience are two of the many motivation factors prompting people to upgrade to ever more sophisticated and elaborate security systems for their homes or buildings. People seek security systems that allow them to maximize the security of the building or other space while also minimizing the inconvenience and cost associated with the additional security.

One way to maximize security is to secure the building using conventional locks, security systems, or other access prevention methods. Locking a building, activating the security system, or generally preventing access may effectively prevent access to everyone who does not have the key configured to allow the holder to bypass whatever access prevention methods are being used.

However, using access prevention methods can effectively deny access to everyone who does not have a key. There may be times when preventing all access to a person is not desirable, but neither is providing a key to that person that would allow continuous access. Examples could includes providing access to a cleaning service, providing access to a visitor when running late for an appointment, providing access to children returning from school, etc.

Present systems exist that provide remote access using a communication device and a control circuit capable of controlling a lock or other prevention method to provide access. However, such systems are generally expensive and require structural modifications to access points to provide the necessary equipment that allows for providing access from a remote location. Further, specialized equipment can be required such as locks capable of being secured or unsecured based upon receipt of a signal.

Thus, there is a need for a system or method for providing access to a remote location using a key or other bypass method. Further, there is a need to provide this system or method in a manner such that access is provided one time based on a communication from a communication device. Further, there is a need to provide this system or method in a manner that does not require retrofitting of the access point. Further, there is a need to provide the system or method in a manner that is cost efficient.

### SUMMARY OF THE INVENTION

One embodiment of the invention relates to an apparatus for providing access to a secured space from a remote location. The apparatus includes a control circuit, a communication device coupled to the control circuit and configured to send and receive data to and from a remote location, an access means configured to provide access to the secured space, and an access means retention device coupled to the control circuit and configured to provide access to the access means stored therein based on a communication using the communication device.

A second embodiment of the invention relates to an apparatus for providing access to a secured space from a remote location. The apparatus includes a bracket for mounting to apparatus proximate to the secured space, a communication device for providing communication from the apparatus to a person controlling access, an optical device for capturing images for transmission using the communication device, an access means configured to provide access to the secured space, a secured box containing the access means configured to receive a lock or unlock signal from the communication device.

A third embodiment of the inventions relates to a method for providing access to a secured space from a remote location. The method includes providing a communication channel to a person seeking entry, transmitting a request for access to a remote location, receiving a signal authorizing provision of access, and providing access to an access means configured to provide access to the secured space based upon receipt of the signal authorizing provision of access.

### BRIEF DESCRIPTION OF THE DRAWINGS

FIG. 1 is a general diagrammatical representation of a system and method for providing remote access to a secured building according to an exemplary embodiment;

FIG. 2 is a general diagrammatical representation of an exemplary system for providing remote access to a secured building using a key according to an exemplary embodiment;

FIG. 3 is a general diagrammatical representation of a side view of an exemplary key box attached to the system for providing remote access to a secured building using a key of FIG. 2 according to an exemplary embodiment; and

FIG. 4 is a flow diagram of steps in a method for providing access to a building from a remote location according to an exemplary embodiment.

### DETAILED DESCRIPTION OF EXEMPLARY EMBODIMENTS

A system for and method of providing access to a secured building from a remote location by providing access to a device or some information that enables access are described. In the following description, for purposes of explanation, numerous specific details are set forth in order to provide a thorough understanding of the present invention. It will be evident, however, to one skilled in the art that the exemplary embodiment may be practiced without these specific details. In other instances, structures and devices are shown in block diagram form in order to facilitate description of the exemplary embodiments.

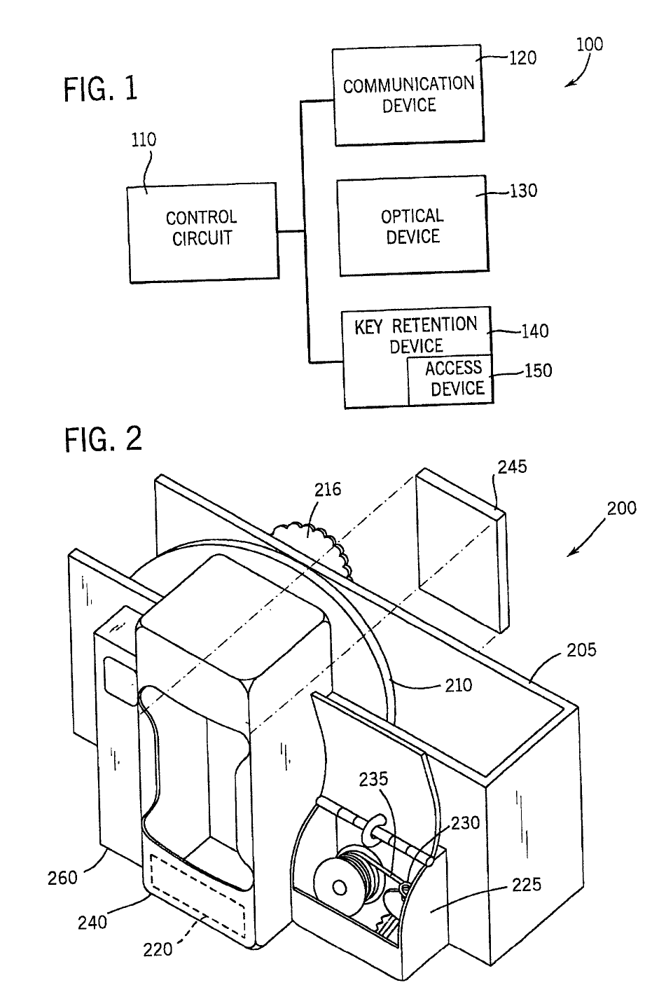

Referring to FIG. 1, FIG. 1 is a block diagram illustrating a system 100 for providing access to a secured building from a remote location by providing access to a device or some information that enables access. According to an exemplary embodiment, the system may include a control circuit 110, a communication device 120, an optical transmission device 130, a key retention device 140, and an access device 150.

Control circuit 110 may be configured to control the various components of system 100, to store data in memory, to operate programmed functionality, etc. Control circuit 110 may includes various types of control circuitry, digital and/or analog, and may include a microprocessor, micro-controller, application-specific integrated circuit (ASIC), or other circuitry configured to perform various input/output, control, analysis, and other functions to be described herein. Control circuit 110 is coupled to communication device 120, optical device 130, and retention device 140 so as to be able to send and receive data and control signals to and from these components.

Communication device 120 may be a cellular phone, a connection to a standard phone line, a connection to a data network, or any other type of device or connection capable of sending and receiving data to and from a remote location. Communication device 120 can be connected to an external communication point by a wired or a wireless connection. The external communication point can include a link to an external network, a phone line, a cellular antenna, or any other device for sending a receiving data. A wireless communication device 120 provides an advantage that no structural modifications or external wires need to be performed or installed to connect communication device 120 to the external communication point.

According to an exemplary embodiment, communication device 120 can be configured to send and receive data from control circuit 110. Additionally, communication device 120 can be configured to send and receive data from a single or a plurality of remote communication devices. Where communication with a single remote communication device is desired, communication device 120 can be configured to connect to a single remote telephone where a person controlling access to the building is generally available. Alternatively, communication device 120 can be configured such that a user can select from a plurality of preset locations where a person or people controlling access to the building is/are generally available.

According to an exemplary embodiment, communication device 120 can be a cellular phone. The functionality to connect to a limited, pre-defined number of locations can be controlled using a cellular phone speed dial function as is well known in the art. For example, where communication device 120 is a cellular phone including a speed dial function, the number one on the keypad can be associated with the owner of the building's remote location, the number two can be associated with a second occupant of the building, etc. Thereafter, access to the cellular phone can be restricted such that the only functionality available to a person seeking access is the keypad number that have been programmed to speed dial, the “SEND” button, and the “END” button. An example of hardware that can be used to mount the communication device 120 and provide restricted access to functionality is discussed in detail below with reference to FIG. 2.

According to an alternative embodiment, communication device 120 can be a connection to a network. According to an exemplary embodiment, the network can be the Internet, a virtual private network (VPN), and Ethernet, a Netware network, or any other network that can send and receive data from system 100 to and from a person controlling access to the building.

The connection to the network can be a wired connection or a wireless connection. Where a wireless connection is used, the network can be configured to communicate using Infrared Direct Access (IrDA) protocol, the Bluetooth short range radio network protocol, the IEEE 802.11 protocol, the HomeRF single wireless access protocol, the IEEE 802.11b wireless fidelity protocol, or any other protocol for sending information wirelessly from system 100.

According to an exemplary embodiment, communication device 120 can include a voice and/or alphanumeric input and a connection to a wireless network. Communication device 120 can be configured to receive input from a person seeking access and transmit the received data to a person controlling access through a predefined channel. The channel can utilize a streaming data link, a secondary application such as an email program, a paging system, or a voice transmission channel. The person controlling access can receive the message and transmit a response to system 100 over communication device 120.

According to an exemplary embodiment, optical device 130 may be a camera. The optical device 130 can be coupled to the control circuit 110 and configured to send data from optical device 130 through control circuit 110 to communication device 120. According to alternative embodiments, the optical device 130 can be a still image camera or a video camera capable of taking live video. The optical device 130 may be physically positioned such that the person seeking access using system 100 is framed in the image or images captured by optical device 130.

Key retention device 140 may be any device capable of holding an access device 150 for entry into the restricted space associated with system 100. Key retention device 140 may be a physical space configured to contain and protect an access device 150, such as a key. Alternatively, key retention device 140 may be configured to hold an alternative type of access device 150, such as a pass card, a door remote control such as a garage door opener, or any other type of access device.

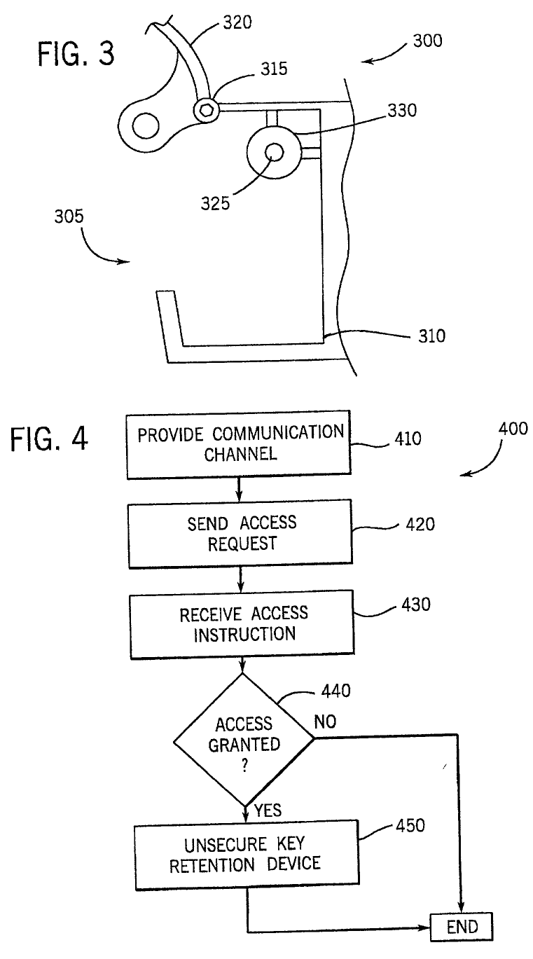

Key retention device 140 may be configured to hold and protect the access device 150 from external factors, such as a person attempting to gain unauthorized entry, the weather, etc. Key retention device 140 may further include a locking mechanism coupled to control circuit 110, such that the lock may be disabled upon proper access through system 100 allowing access to the access device 150 stored therein. An exemplary embodiment for key retention device 140 and associated components is discussed in further detail with reference to FIG. 3.

According to an alternative embodiment, key retention device 140 may be a device configured to provide data upon proper access using system 100. For example, key retention device 140 may include a display screen configured to display a keypad number or code upon proper access using system 100. The access device 150 in this exemplary embodiment may be the information that can be used to gain entry into the restricted space associated with system 100. For example, key retention device 140 may be used to display a number to be entered on an associated keypad that will allow access. To further protect security, the code may be a rolling or otherwise changing code such that only one time access is provided to the person seeking access using system 100.

In operation, according to an exemplary embodiment, communication device 120 can include a modem jack or a data port. The modem jack or data port can be configured to provide a signal to key retention device 140. For example, communication device 120 can include a communication device based application to send a signal through the modem jack or data port. A communication device based application can be any set or subset of instructions executable using a communication device. A communication device based application can be an application written for a communication device based programming interface such as PalmOS, Symbian OS, or JavaPhone. To further increase security, the signal may be encoded.

According to an alternative embodiment, a separate control circuit can be provided that runs a Rivest, Shamir, & Adleman Access Capacity Enhancement (RSA ACE) Server. An RSA ACE/Server is a public key encryption technology which generates a new key code every few minutes. The person controlling access carries an RSA token that is in sync with the RSA ACE/Server and which display the same key code which is active on the server. The person controlling access can communicate the key code to the person seeking entry for entry on a keypad associated with the RSA ACE/server. The control circuit can then send a signal to key retention device 140 to allow access.

Advantageously, system 100 does not require modification to the structure of the building or other secured area to which access is to be provided. Not requiring structural modifications reduces the expense and inconvenience of utilizing the system.

Referring now to FIG. 2, FIG. 2 is a general diagrammatical representation of a system 200 for providing remote access to a building according to an exemplary embodiment. System 200 includes a bracket 205, a rubber pad 210, a tightening handle 215, a battery housing 220, a key retention device 225, a key ring 230, a spring loaded cable spool 235, a cellular phone holder 240, a cellular phone face plate 245, and a camera holder 250.

According to an exemplary embodiment, system 200 may include components allowing a user to secure the system 200 to a door where the user wants to be able to provide remote access. According to the embodiment shown in FIG. 2, bracket 205 can be configured in a U shape such that system 200 can be slid over the edge of a door. Bracket 205 can be configured such that it does not interfere with the normal closing and locking of the door. The bracket can be further held in place by tightening handle 215 which can be coupled to rubber pad 210. Tightening handle 215 can be used to push rubber pad 210 into the door to secure system 200 against vertical displacement. The rubber pad provides the advantage of increased friction between the door and system 200 and also protects the door from damage.

Bracket 205 may be configured to be slipped over the edge of the door and secured in place. Prior to clamping down tightening handle 215, system 200 can be positioned such that the camera is at an approximated face level. System 200 can also be positioned such that key ring 230 is within reach of the lock securing the door after being extended from spring loaded cable spool 235.

Battery housing 220 can be any type of battery housing capable of holding a battery to provide additional power to system 200. Provision of a battery housing 220 provides the advantage of longer component life to communication device 120, optical device 130 and key retention device 225. According to an alternative embodiment, battery housing 220 can be replaced by a solar cell or other component capable of delivering power to system 200.

Key retention device 225 can be a box having a hinged lid to control access to the access device stored therein according to an exemplary embodiment. The key retention device 225 can be configured to contain spring loaded cable 235 and key ring 230. The key ring retention device 225 is described in further detail below with reference to FIG. 3.

Spring loaded cable 235 and key ring 230 can be configured to hold and retain keys within key retention device 225. Key ring 230 can be configured to hold keys providing access to the door on which system 200 is mounted. The keys can be interchangeable such that system 200 can be used on any door and the key to that door can be place on key ring 230. Spring loaded cable 235 can be configured to contain a sufficient length cable that can be drawn out to allow a person seeking entry to remove the keys from key retention device 225 and extend them to the lock. Provision of the spring loaded cable 235 encourages users to return the key to key retention device 225 such that the system in ready for future use. Spring load cable 235 can be of sufficient durability to minimize the risk of breakage.

Cellular phone holder 240 can be provided to house a cellular phone to be used as a communication device to contact a person controlling access. Cellular phone holder 240 can be constructed of sufficient durability to prevent interference with the intended operation of system 200. Cellular phone holder 240 can be configured to provide a power coupling between the cellular phone to be stored therein and battery housing 220.

Cellular phone holder 240 can be further configured to receive cellular phone face plate 245. Cellular phone face plate 245 can be positioned such that plate 245 is positioned between the cellular phone and a person seeking to use system 200. Cellular phone face plate 245 can be configured to provide limited access to the cellular phone such that the user can only access the functionality related to the operation of system 200. Cellular phone face plate 245 can further be configured such that it protects the cellular phone from interference and weather.

Camera holder 250 can be provided to house an optical device 130, described with reference to FIG. 1, to be used to capture and transmit images of a person seeking access using system 200. Camera holder 250 can be positioned such that a person seeking to use system 200 will be framed within an image capture by a camera stored therein.. Camera holder 250 can be constructed of sufficient durability to prevent interference with the intended operation of a camera associated with system 200. Camera holder 250 can be configured to provide a power coupling between the camera to be stored therein and battery housing 220. Camera holder 250 can be further configured to provide a data coupling between the optical device to be stored therein and communication device 120.

In operation, a person seeking the capability to provide remote access to a building can utilize system 200. The person can attach system 200 to any door in any location where remote access provision is desired.

The person controlling access can program the speed dial on a cellular phone to provide a phone number from which they want to be able to provide remote access. The phone number can be to an office, another cellular phone, or any other location. The cellular phone can be installed in cellular phone holder 240 such that only that speed dial functionality can be accessed.

Further, a camera can be inserted in the camera holder 250 and the appropriate key attached to key ring 230. The camera can be configured such that it is controllable by communication device 120 in a manner similar to key retention device 140, described above with reference to FIG. 1. Thereafter, the device can be mounted securely to the door associated with the key retained on key ring 230.

A person seeking entry can then use system 200 to gain access to the key to unlock the door. The person seeking entry can hit the appropriate speed dial number followed by the “SEND” key on the cellular phone. A conversation could ensue between the person seeking entry and the person controlling access.

If remote access provision is desired, the person controlling access can enter a code to cause communication device 120 to provide a signal to key retention device 225 to allow access, discussed above with reference to FIG. 1. According to an alternative embodiment, the person controlling access can communicate an access code that is valid for a singular entry to be used by the person seeking entry. According to another alternative embodiment, the communication device uses an http data access to access a web address controlled by the owner for an encoded access key. The person controlling access could change the encoded key during a call to prevent repeated access.

Advantageously, system 200 can be associated with any door as desired by the user. It can be placed on a front door when service people are expected to provide remote access for service. Alternatively, if the user did not desire a conspicuous placement on the front door, the same system could be moved to a rear door to provide access to a person who knew of the placement of the rear door. The same system could be transported to a vacation cottage or other location where it may be desirable to provide access. The portability of the system is further enhanced because no structural modification need to be made to the doors or surrounding infrastructure to provide the remote access. According to an alternative method, the bracket can be attached to a cubicle doorway in a work environment and secured with a computer cable or a chain.

Referring now to FIG. 3, FIG. 3 is a general diagrammatical representation of a key retention device 300 according to an exemplary embodiment. Key retention device 300 can include a key box 310, a key box door 320 and a solenoid 330.

The key box 310 can be configured to securely house a key or other access device. The key box 310 can be further configured to house the solenoid 330. The key box 310 can include an opening 305 covered by the key box door 320. The key box door can be pivotably secured to the key box 310 by a hinge 315.

The solenoid 330 can be configured to be coupled to communication device 110, discussed above with reference to FIG. 1, such that the solenoid is controlled by control circuit 110. Solenoid 330 can include a shaft 335 configured to secure key box door 320 to key box 310 such that access to key box 310 is prevented.

In operation, when access to the key box 310 is not authorized, solenoid 330 positions shaft 335 such that key box door 320 is secured to key box 310, preventing access. When access is authorized, a control signal can be sent from control circuit 110 to solenoid 300. Solenoid 330 can be used to position shaft 335 such that key box door 320 can be opened and access to the contents of key box 310 is provided. Advantageously, key box 310 can utilize simple and inexpensive components to effectively control access to the contents of key box 310.

Referring now to FIG. 4, FIG. 4 is a flow diagram 400 depicting a method for providing access from a remote location. Although the series of steps are described in order, it is understood that more or less steps can be performed in any order to provide access from a remote location.

A step 410 can be performed wherein a communication channel is provided to a person seeking entry. According to an exemplary embodiment, the communication channel can be a cellular phone channel configured to provide communication between the person seeking access and the person controlling access. The communication channel can be established by the person seeking access by, for example, dialing a phone number from the cellular phone.

After the communication channel has been established, a step 420 can be performed wherein a request for access is provided over the communication channel. The request can be made by voice communication, alphanumeric communication or any other means that communication an access request from the person seeking entry to the person controlling entry. The request can further be associated with a greater or lesser amount of data. For example the request can include an identity verification, such as an image taken of the person seeking entry, or a biometric input, such as a scan from a fingerprint reader.

The person controlling entry can receive the access request and any associated data in a step 430. Following receipt of data a determination is made in a step 440 whether access should be granted to the person seeking access. If access is to be denied, the system exits.

If access is to be granted, a step 450 can be performed wherein the person controlling access can send a signal over the communication channel to a box containing an access device. The signal can unlock the box, allowing the person seeking entry to obtain a key that will allow access.

While the exemplary embodiments illustrated in the FIGURES and described above are presently preferred, it should be understood that these embodiments are offered by way of example only. Other embodiments may include, for example using the described system and method to control access to some other defined space, such as a room, a vault, a box, etc. The invention is not limited to a particular embodiment, but extends to various modifications, combinations, and permutations that nevertheless fall within the scope and spirit of the appended claims.

What is claimed is:

1. An apparatus for providing access to a secured space from a remote location, comprising:
a control circuit;
a communication device coupled to the control circuit and configured to send and receive data to and from and remote location; and
an access means configured to provide access to the secured space; and
an access means retention device coupled to the control circuit and configured to provide access to the access means stored therein based on a communication using the communication device.

2. The apparatus of claim 1, the apparatus further including a optical device coupled to the control circuit and configured to capture images for transmission using the communication device.

3. The apparatus of claim 2, wherein the optical device is a video camera configured to capture a video image.

4. The apparatus of claim 1, where the access means can be changed to provide access to a variety of secured spaces.

5. The apparatus of claim 4, wherein the access means is a key.

6. The apparatus of claim 5, wherein the apparatus further includes a mounting means for securing the apparatus in a location proximate to the secured space that can be secured and unsecured using the access means.

7. The apparatus of claim 1, wherein the communication device is a cellular phone.

8. The apparatus of claim 7, wherein access to the cellular phone is restricted to provide limited functionality.

9. An apparatus for providing access to a secured space from a remote location, the apparatus including:
a bracket for mounting to apparatus proximate to the secured space;
a communication device for providing communication from the apparatus to a person controlling access;
an optical device for capturing images for transmission using the communication device;
an access means configured to provide access to the secured space; and
a secured box containing the access means configured to receive a lock or unlock signal from the communication device.

10. The apparatus of claim 9, wherein the optical device is a video. camera configured to capture a video image.

11. The apparatus of claim 9, where the access means can be changed to provide access to a variety of secured spaces.

12. The apparatus of claim 11, wherein the access mean is a key.

13. The apparatus of claim 9, wherein the communication device is a cellular phone.

14. The apparatus of claim 13, wherein access to the cellular phone is restricted to provide limited functionality.

15. A method for providing access to a secured space from a remote location, comprising:
providing a communication channel to a person seeking entry;
transmitting a request for access to a remote location;
receiving a signal authorizing provision of access; and
providing access to an access means configured to provide access to the secured space based upon receipt of the signal authorizing provision of access.

16. The method of claim 15, wherein the step of providing a communication channel includes using a cellular phone to establish the communication channel.

17. The method of claim 15, wherein the request to be transmitted includes identification information.

18. The method of claim 16, wherein the identification information is an image of the person seeking access.

19. The method of claim 15, wherein the step of receiving a signal authorizing provision of access includes monitoring the communication channel for a signal.

20. The method of claim 15, wherein the access means is a key.
